(19) United States
(12) Patent Application Publication
(10) Pub. No.: US 2026/0170037 A1
(43) Pub. Date: Jun. 18, 2026

(54) AI-ASSISTED CONTENT RENDERING MANAGEMENT AND RENDERING CONTROL TECHNIQUES

(71) Applicant: YAHOO ASSETS LLC, New York, NY (US)

(72) Inventors: Umang PATEL, Sunnyvale, CA (US); Ryan Andrew MIHALKO, Phoenix, AZ (US); Bhopal SINGH, San Jose, CA (US); Tejas THVAR, Los Altos, CA (US)

(21) Appl. No.: 18/979,738

(22) Filed: Dec. 13, 2024

(51) Int. Cl. G06F 16/335; G06F 16/383

(52) U.S. Cl. CPC G06F 16/335; G06F 16/383

(57) ABSTRACT

Disclosed are systems and methods that provide a scalable, decision intelligence (DI)-based computerized framework for electronic content communication over an electronic network. The disclosed framework operates to dynamically analyze and leverage electronic messaging interactions, whereby, via deep learning content classification operations, the framework generates nuanced interaction mappings through comprehensive semantic analysis of message content, metadata, engagement signals, and the like. The framework provides novel capabilities to dynamically adapt to evolving communication patterns, providing a flexible, intelligent infrastructure that transforms raw messaging data into actionable, contextually relevant communication insights. By implementing continuous learning algorithms and probabilistic classification models, the disclosed framework ensures comprehensive coverage and improved precision in understanding digital communication dynamics.

### FIELD OF THE DISCLOSURE

The present disclosure relates to electronic communications of digital content and messages, and more particularly, to a decision intelligence (DI)-based computerized framework for communicating content for customized interactions and rendering instances.

### SUMMARY OF THE DISCLOSURE

According to some embodiments, the disclosed systems and methods provide a retargeting (RT) framework for digital content communication. As discussed herein, the disclosed framework provides an advanced communication platform that operates to dynamically analyze and leverage electronic communications and interactions for customized interaction and rendering instances for receiving users and/or the applications/devices used by such users. By employing deep learning content classification models, the disclosed framework generates nuanced user-entity interaction mappings through comprehensive semantic analysis of communications content, metadata, action signals, and the like. The computerized framework can utilize artificial intelligence (AI) architectures to perform real-time domain categorization, sensitive content filtering and multi-dimensional relationship determination across communication ecosystems. Moreover, through advanced machine learning (ML) models, the framework creates fine-grained user cohorts based on precise content interactions, enabling highly targeted digital content delivery mechanisms.

Accordingly, in some embodiments, the instant disclosure provides novel capabilities to dynamically adapt to evolving communication patterns, providing a flexible, intelligent infrastructure that transforms raw data into actionable (e.g., executable by a receiving application), contextually relevant communication analysis and output. By implementing continuous learning algorithms and probabilistic classification models, the disclosed framework ensures comprehensive coverage and improved precision in understanding digital communication dynamics.

According to some embodiments, a method is disclosed for an AI-based computerized framework for communication retargeting. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for electronic mail retargeting.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed RT framework represents a sophisticated approach to digital advertising targeting, fundamentally revolutionizing how user intent and brand (e.g., entity) interaction are analyzed and leveraged for precise ad campaign delivery. At its core, the framework introduces a transformative methodology for dynamically understanding user-brand relationships through advanced machine learning techniques applied to email and messaging content analysis.

According to some embodiments, a critical innovation in the RT framework is the Domain Categorization component, which employs a deep learning-powered content classifier to dynamically characterize message content and sender domains. Traditional domain categorization methods relied on static, predefined mappings that remained unchanged regardless of temporal variations or contextual shifts. In contrast, the disclosed novel mechanisms utilize a sophisticated AI (e.g., neural network, for example) architecture capable of analyzing message content at a granular level, generating nuanced categorizations that adapt to evolving communication patterns.

In some embodiments, as discussed in more detail below, the deep learning classifier operates through a multi-stage processing pipeline. By way of example, in some embodiments, initially, the classifier ingests raw message content, preprocessing the text through advanced natural language processing techniques such as tokenization, semantic embedding, and contextual feature extraction. The neural network model, which can be implemented using transformer-based architectures like BERT or its derivatives, can capture complex linguistic patterns and contextual nuances that traditional rule-based systems would miss. By analyzing the aggregated message tags over a time period (e.g., 21-day rolling window), the framework develops a dynamic, continuously updated understanding of each domain's communicative characteristics.

In some embodiments, the Dynamic Categorization component represents a significant departure from static domain mapping approaches. Instead of relying on predetermined, immutable classifications, the disclosed framework performs real-time, per-message classification. This approach introduces several critical advantages: enhanced adaptability to seasonal variations, improved handling of evolving brand communication strategies and mitigation of data drift challenges that plague traditional categorization methodologies.

According to some embodiments, the AI model (e.g., neural network, for example) driving such dynamic categorization can employ transfer learning techniques, enabling rapid adaptation to new communication contexts while maintaining robust generalization capabilities. By analyzing individual message content in real-time, the framework can detect subtle shifts in brand communication that might indicate strategic changes, market responses, or emerging communication trends. Such granular, dynamic approach provides advertisers with improved insights into brand messaging evolution.

In some embodiments, user engagement analysis provides another novel component to the RT framework. Previous targeting methodologies predominantly relied on message receipt volume as a proxy for user interest, a flawed approach that fails to distinguish between meaningful engagement and passive message accumulation. The disclosed framework introduces a sophisticated “Open Engagement vs. Receive” mechanism that prioritizes actual message interactions as the primary intent signal. Thus, for example, by tracking user message opens rather than mere receipts, the framework captures a significantly more nuanced representation of user-brand interaction. Such mechanisms provide capabilities for determining that a message receipt is a passive signal, potentially contaminated by automated filtering, spam, or disinterest. Message opens, conversely, represent an active user choice, signaling genuine interest or intentional engagement.

In some embodiments, the framework's mechanisms for handling sensitive domains demonstrates a sophisticated understanding of data compliance and ethical considerations. By implementing advanced domain categorization techniques specifically designed to identify and filter sensitive message categories—such as healthcare, financial services, or personally identifiable communications—the RT framework ensures robust privacy protection and regulatory compliance.

In some embodiments, the technical implementation of such sensitive domain filtering can involve a specialized classification model trained on labeled datasets representing various sensitive communication domains. Such model can be employed via techniques such as, for example, multi-class classification with probabilistic filtering, enabling nuanced decision-making about domain sensitivity. ML techniques such as support vector machines or ensemble methods can also be leveraged to create a robust, adaptable filtering mechanism.

The disclosed RT framework provides a paradigm shift in digital advertising targeting, moving beyond simplistic, static approaches toward a dynamic, intelligence-driven methodology. By combining advanced deep learning techniques, nuanced user engagement analysis, and sophisticated domain categorization, the framework offers advertisers improved precision in understanding and targeting user intent. Moreover, the technical innovations described-dynamic content classification, active engagement tracking, and sensitive domain filtering-collectively create a comprehensive, adaptive framework for digital advertising targeting. This approach not only enhances advertising effectiveness but also respects user privacy and provides a more intelligent, context-aware targeting mechanism.

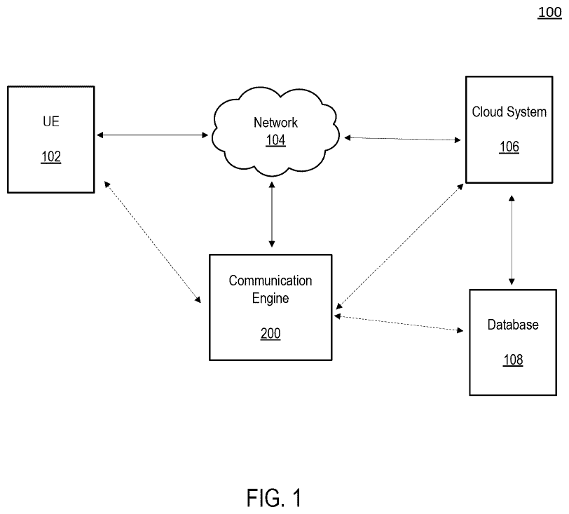

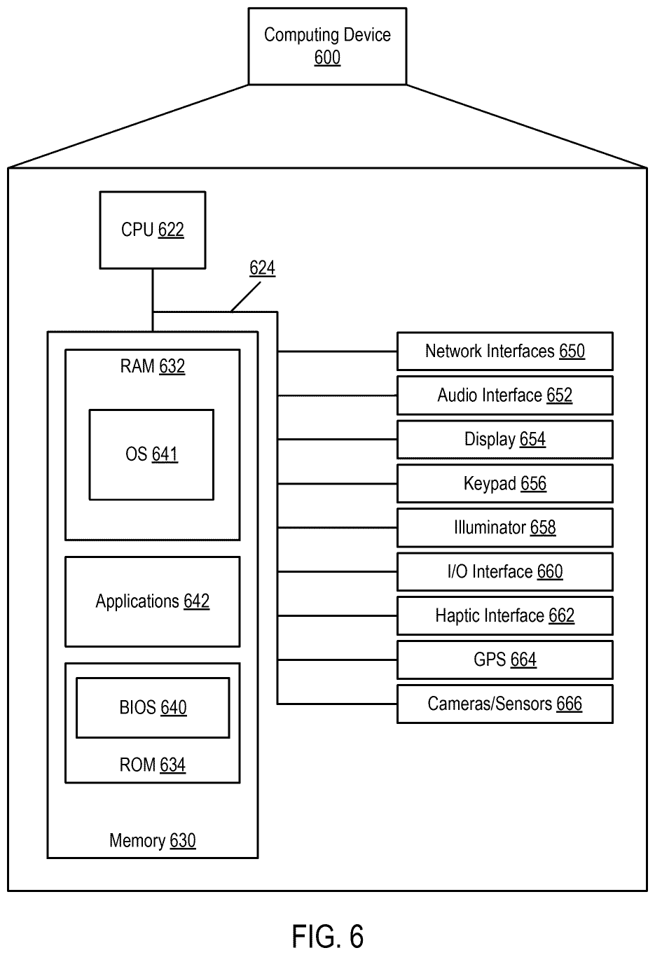

With reference to FIG. 1, system 100 is depicted which includes user equipment (UE) 102 (e.g., a client device, as mentioned above and discussed below in relation to FIG. 6), network 104, cloud system 106, database 108, and communication engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic mail platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or communication engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

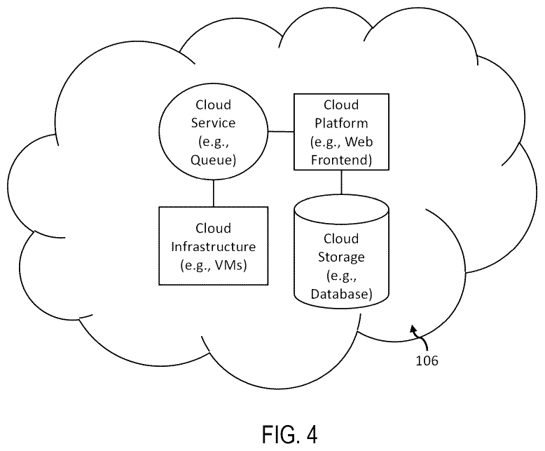

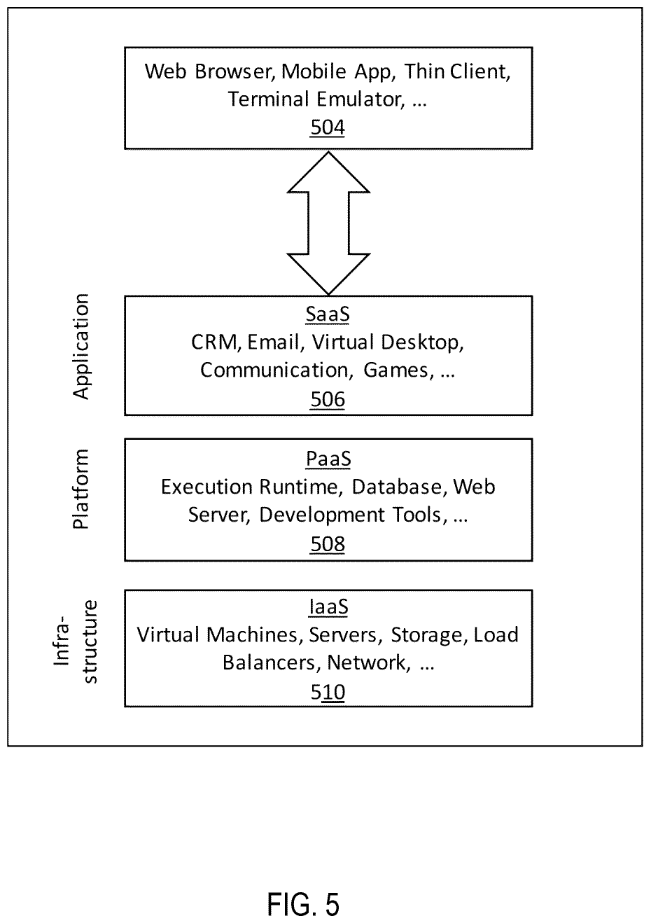

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (Saas) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Communication engine 200, as discussed above and further below in more detail, can include components for the disclosed functionality. According to some embodiments, communication engine 200 may be a special purpose machine or processor, and can be hosted by a device on network 104, within cloud system 106, and/or on UE 102. In some embodiments, engine 200 may be hosted by a server and/or set of servers associated with cloud system 106.

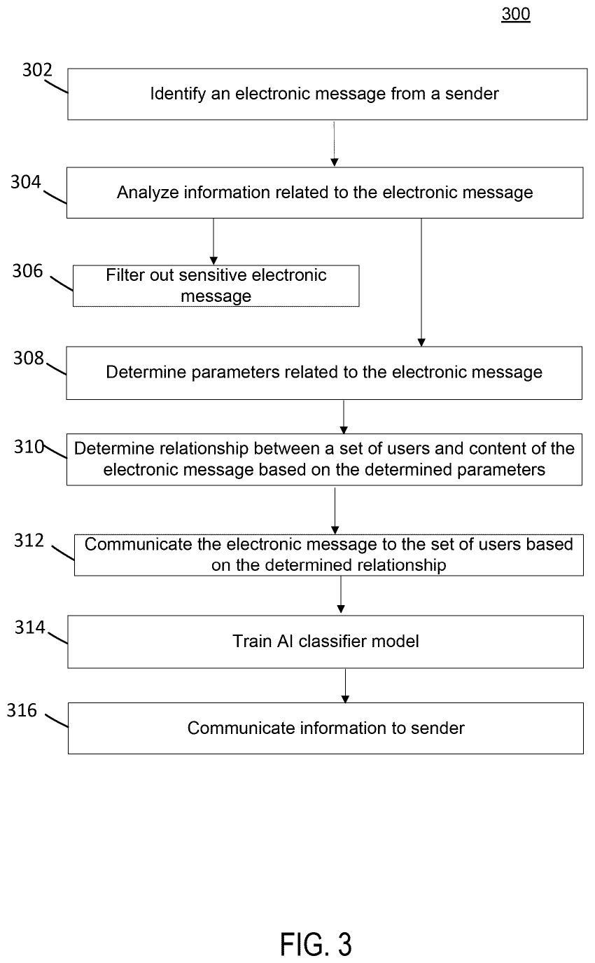

According to some embodiments, as discussed in more detail below, communication engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, communication engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

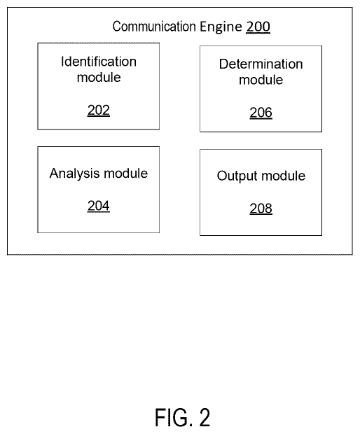

As illustrated in FIG. 2, according to some embodiments, communication engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Communication engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for a DI-based computerized framework for electronic mail retargeting.

By way of background, conventional RT systems are fundamentally limited in ad segmentation, due to at least their reliance on static, outdated domain lists that fail to capture the dynamic nature of digital communication ecosystems. These existing targeting strategies suffer from critical architectural limitations that substantially impede the precision and effectiveness of advertising campaigns. Indeed, the primary deficiency in the current system stems from its dependence on domain lists that rapidly become obsolete, often remaining unchanged for years. Such static categorizations fail to account for the continuous evolution of digital communication strategies, brand messaging, and user interaction patterns. Consequently, advertisers are forced to operate with a severely restricted and increasingly irrelevant dataset that does not reflect the current communication landscape.

For example, the coverage limitations of the existing approaches are particularly pronounced. With only approximately 70% of domains being categorized, a significant 30% of potential targeting opportunities remain unexplored. This substantial coverage gap represents a critical missed opportunity for advertisers seeking comprehensive audience engagement strategies. The inability to accurately classify and target these uncategorized domains results in substantial potential revenue loss and diminished advertising effectiveness.

To that end, the disclosed systems and methods provide a novel, computerized RT framework that leverages and integrates advanced deep learning content classification techniques to fundamentally transform this targeting paradigm. By implementing a sophisticated neural network-powered classification system, the methodology can generate fine-grained, dynamically updated tags that provide improved granularity in domain and communication characterization.

As discussed herein, the deep learning content classifier operates through a complex, multi-dimensional analysis process. The framework can operate to ingest, via the classifier(s)/model(s), message content, performing advanced natural language processing (NLP) to extract semantic nuances, contextual signals, communication patterns, and the like, that traditional static classification methods would invariably miss. This approach enables a level of domain understanding that goes far beyond simple categorical assignment, instead creating a rich, multifaceted representation of digital communication characteristics.

In some embodiments, the disclosed aggregation pipeline transforms these fine-grained tags into a comprehensive targeting mechanism. By dynamically generating and continuously updating domain classifications, the framework can create targeting cohorts with significantly enhanced precision and relevance. This approach moves beyond the limitations of static domain lists, introducing a fluid, adaptive targeting methodology that can respond in near-real-time to evolving communication trends.

Moreover, a significant advantage of the instant disclosure is the ability to achieve 100% domain coverage, a substantial improvement over the existing 70% limitation. By employing deep learning techniques that can analyze and categorize previously uncovered domains, the framework eliminates the substantial blind spots inherent in current targeting methodologies. This comprehensive coverage ensures that advertisers can access a complete view of potential targeting opportunities.

Furthermore, the quality of targeting signals generated through this content classification approach represents an improvement in advertising precision. By analyzing message content at a granular level, the system can extract nuanced user intent signals that traditional methods would overlook. These higher-quality signals enable the creation of more accurate, contextually relevant user cohorts, substantially improving the potential effectiveness of advertising campaigns.

Even further, the fine-grain cohort reporting mechanism provides an improved level of targeting granularity. Advertisers can now develop user-level, domain-specific retargeting strategies that account for subtle variations in communication patterns, user engagement, and brand interactions. This level of precision allows for highly personalized, contextually relevant advertising approaches that can significantly improve conversion rates and user engagement.

Accordingly, by replacing static, outdated domain lists with a dynamic, deep learning-powered classification framework, the disclosed methodology represents a fundamental reimagining of digital advertising targeting. The approach offers advertisers a more intelligent, adaptive, and comprehensive framework for understanding and engaging with potential stakeholders.

According to some embodiments, Step 302 of Process 300 can be performed by identification module 202 of communication engine 200; Step 304 can be performed by analysis module 204; Steps 306 and 312-316 can be performed by output module 208; and Steps 308 and 310 can be performed by determination module 206.

According to some embodiments, Process 300 begins with Step 302 where an electronic message including digital content is identified/received. The message and/or content are provided by a sender (e.g., advertiser or entity for which entity or brand information is to be disseminated electronically to a user or users over the Internet). Such content can correspond to a product, item or service of the sender and/or another user or entity. In some embodiments, Step 302 can involve identifying data points related to the message, which can include, but are not limited to, sender information (e.g., email address, domain, historical sender reputation, previously tagged categories associated with the sender, and the like), message metadata (e.g., content topic, content type, timestamp of receipt, subject line, attachment presence, message size, and the like), recipient context (e.g., whether the message is addressed directly, as part of a group, to a type of demographic of users, or via carbon copy (CC), and the like), and the like, or some combination thereof. Thus, the identification process of Step 302 can ensure identified messages and/or content types are tagged and queued for analysis by downstream components, regardless of its classification.

In Step 304, engine 200 can perform operations to analyze the electronic message. According to some embodiments, the message analysis step represents a sophisticated, multi-dimensional information processing pipeline that transforms raw message data into structured, actionable intelligence. The operations of Step 304 can employ advanced natural language processing (NLP) and/or ML techniques to extract nuanced semantic insights from message content.

According to some embodiments, such analysis can commence with comprehensive content preprocessing, involving tokenization, semantic parsing, and feature extraction. Advanced transformer-based neural network (NN) models, such as, for example, BERT or its derivatives, can perform deep semantic analysis that goes beyond traditional keyword-based approaches. Such models can capture complex linguistic nuances, contextual dependencies, implied semantic meanings embedded within the message content, and the like.

In some embodiments, semantic embedding techniques generate high-dimensional vector representations of message content, enabling sophisticated computational analysis. These embedding models can capture subtle semantic relationships, topic coherence, and communication intent that traditional text analysis methods would invariably miss. The embedding process considers multiple linguistic dimensions, including syntactic structure, semantic context, and pragmatic communication signals.

In some embodiments, the analysis step can extract, via the NLP operations, informational insights from the message and/or content included therein. In some embodiments, initial processing stages perform basic content categorization, identifying broad communication domains and message types; while, in some embodiments, subsequent analysis layers can introduce progressively more granular semantic understanding, generating complex, multi-dimensional content representations.

According to some embodiments, ML models integrated into the analysis pipeline can dynamically adapt their semantic understanding based on observed communication patterns. Transfer learning techniques enable the system to continuously refine its semantic analysis capabilities, incorporating new linguistic patterns and communication trends. Such adaptive approach ensures that the analysis framework remains responsive to evolving communication strategies.

In some embodiments, engine 200 can utilize advanced anomaly detection and outlier identification mechanisms that can be integrated into the analysis of Step 304. Such techniques can identify unusual communication patterns, semantic discontinuities, and statistically significant deviations from expected message characteristics. By implementing sophisticated statistical and machine learning-powered anomaly detection, engine 200 can generate valuable insights about emerging communication trends.

In some embodiments, the computational analysis performed in Step 304 can involve engine 200 calling and executing an AI, ML and/or LLM model. Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

Accordingly, analysis of Step 304 involves extensive configurability, enabling fine-tuned customization of semantic extraction processes. Domain-specific analysis models can be dynamically loaded, allowing the system to adapt its semantic understanding across diverse communication domains. This flexibility ensures that engine 200 can provide valuable insights across multiple communication contexts.

In some embodiments, upon performing Step 306, engine 200 can determine that the message corresponds to sensitive content (e.g., of a particular type-for example, medical information for the user, or other forms of personalized data). Thus, as discussed herein, engine 200 can filter out such data and tag as sensitive information, which can ensure data compliance and protect user privacy.

In Step 308, engine 200 can operate to perform operations for determining parameters related to the electronic message. Accordingly, as discussed herein, Step 308 involves a parameter determination phase that transforms raw message data into actionable targeting intelligence. Such sender rollup level analysis involves creating multi-dimensional representations of communication patterns, aggregating historical messaging data across a configurable time window-for example, the past n days (e.g., 21 days) stored in the master database. Such approach enables a dynamic, temporally adaptive understanding of sender characteristics that goes beyond static domain categorizations.

Step 308 further can involve topic coverage analysis operations as part of the parameter determination process. According to some embodiments, by utilizing advanced deep learning content classification techniques, engine 200 can perform granular semantic analysis of message content, extracting weighted topic values that provide improved insights into communication themes. Such analysis goes beyond simple keyword matching, instead employing sophisticated LLMs that can capture nuanced contextual meanings and evolving communication strategies.

Step 308 can further involve the determination of user engagement metrics as part of the parameter determination. In some embodiments, engine 200 can comprehensively analyze, via the AI/ML models discussed supra, multiple engagement signals, including click-through rates, message impressions, open durations, subsequent user interactions, and the like, which can be tied to the message, content and/or sender's previous messages/content. By integrating such diverse engagement indicators, engine 200 can compile information indicating user-message interactions that provide targeting intelligence of how sender content/messages are interacted with by other users, portals, applications, devices, and the like.

In Step 310, engine 200 can leverage the parameters (from Step 308) to determine relationships between the message/content and a set of users (or user sets). Such relationship determination process utilizes deep learning models (e.g., AI/ML models, discussed supra) to generate sophisticated user-brand interaction maps based on intricate connections between message characteristics, content characteristics, user behaviors, user demographics/characteristics, advertising opportunities, and the like.

According to some embodiments, the operations of Step 310's relationship determination can involve multiple relationship dimensions being analyzed simultaneously, where such dimensions can be tied to layers of data that include, but is not limited to, engagement metrics, implicit communication signals, temporal interaction patterns, probabilistic intent indicators, and the like. Thus, by employing advanced AI/ML techniques, such as graph neural networks and probabilistic graphical models, for example, engine 200 can determine complex, non-linear relationships that traditional targeting approaches would invariably miss. Such relationships, via the interaction mapping discussed supra, can dictate how, when and/or where (e.g., a context) for which the user receives the message/content in their account (or inbox).

In Step 312, engine 200 can function to cause communication of the message (from Step 302) to the users identified in Step 310. In some embodiments, such communication can involve traditional message delivery (e.g., sent to an inbox or account of a user), and in some embodiments, such communication can involve a personalized targeting approach that considers the nuanced relationship characteristics discovered in Step 310. For example, such targeting mechanism can dynamically adjust message presentation based on the extracted user-brand interaction insights, ensuring maximum relevance and engagement potential. Thus, the actionable/executable transformation of the data can cause the digital content/message to be displayed, rendered and/or provided in a manner that most likely will be engaged with by the receiving user, and/or the user's application (e.g., browser) or device.

In some embodiments, the communication mechanisms of Step 312 can incorporate advanced personalization techniques, including dynamically generated content, contextually relevant messaging formats, precision-targeted delivery mechanisms, and the like, or some combination thereof. By leveraging the rich, multi-dimensional user relationship data, engine 200 can create advertising communications that feel genuinely personalized and contextually aligned with individual user interests.

Underlying this entire process is Step 314, whereby engine 200 can train the model classifiers utilized in the preceding steps of Process 300. continuous learning mechanisms ensure that classifications and targeting capabilities of engine 200 evolve dynamically. For example, the neural network models can undergo continuous refinement, incorporating feedback signals, engagement metrics and newly observed communication patterns. This creates a self-improving targeting system that can adapt to rapidly changing digital communication landscapes.

And, in Step 316, engine 200 can communicate information back to the original message sender. Such feedback mechanism provides transparency and enables further refinement for such sender. For example, by sharing targeted insights and engagement metrics, engine 200 creates a virtuous cycle of communication intelligence that benefits both advertisers and users.

Accordingly, as discussed herein, the disclosed comprehensive approach of Process 300 transforms electronic message handling from a static, limited process into a dynamic, intelligence-driven targeting framework. By integrating advanced deep learning techniques, nuanced content analysis, and sophisticated user relationship modeling, the disclosed RT framework represents a fundamental reimagining of digital advertising targeting methodologies.

FIG. 6 is a schematic diagram illustrating a client device showing an example embodiment of a client device that can be used within the present disclosure. Client device 600 can include many more or less components than those shown in FIG. 6. However, the components shown are sufficient to disclose an illustrative embodiment for implementing the present disclosure. Client device 600 can represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 can optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 can be a liquid crystal display (LCD), gas plasma, light emitting diode (LED), or any other type of display used with a computing device. Display 654 can also include a touch sensitive screen arranged to receive input from an object such as a stylus or a digit from a human hand.

Keypad 656 can include any input device arranged to receive input from a user. Illuminator 658 can provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 can through other components, provide other information that can be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores can be employed to store information that describes various capabilities of Client device 600. The information can then be provided to another device based on any of a variety of events, including being sent as part of a header (e.g., index file of the HLS stream) during a communication, sent upon request, or the like. At least a portion of the capability information can also be stored on a disk drive or other storage medium (not shown) within Client device 600.

Applications 642 can include computer executable instructions which, when executed by Client device 600, transmit, receive, and/or otherwise process audio, video, images, and enable telecommunication with a server and/or another user of another client device. Applications 642 can further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors can be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors can be dual-core processor(s), dual-core mobile processor(s), and so forth.

Computer-related systems, computer systems, and systems, as used herein, include any combination of hardware and software. Examples of software can include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements can vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

One or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure can be downloadable from a network, for example, a website, as a stand-alone product or as an add-in package for installation in an existing software application. For example, exemplary software specifically programmed in accordance with one or more principles of the present disclosure can also be available as a client-server software application, or as a web-enabled software application. For example, exemplary software specifically programmed in accordance with one or more principles of the present disclosure can also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

1. A method comprising:
receiving, by an application, over a network, digital content, the digital content being associated with raw data;
extracting, by the application executing a first artificial intelligence (AI) model including a natural language processing (NLP) model, from the digital content, features obtained via tokenization and semantic parsing and determining parameters associated with the digital content based on the extracted features;
generating, by the application executing a second AI model including a graph neural network, based on connections between the determined parameters and user data that are identified by the second AI model, a user-entity interaction mapping, the user-entity interaction mapping indicating a context for which the digital content is to be communicated to an account of a user;
transforming, by the application, the raw data for the digital content into executable data based on the generated user-entity interaction mapping, the transformation comprising applying a contextually relevant messaging format to the digital content, the executable data enabling a type of interaction with the digital content by a receiving application of the user; and
causing, by the application, over the network, execution of the type of interaction, the executed type of interaction causing the digital content to be dynamically rendered by the receiving application based on the context and the applied messaging format.

2. The method of claim 1, further comprising the transformation involving a set of layers of the raw data, each layer corresponding to a portion of the digital content, such that the type of interaction is configured for each layer.

3. The method of claim 1, further comprising the parameters corresponding to a set of information selected from a group consisting of: topic, a communication pattern, transmitted data across a configurable time window, and engagement data.

4. The method of claim 3, further comprising the configurable time window being a set of rolling days for which the raw data can be retrieved from a database.

5. The method of claim 1, further comprising:
determining that a parameter of the digital content corresponds to a type of content;
filtering the digital content; and
applying a tag corresponding to the type of content to the digital content.

6. The method of claim 1, further comprising the user-entity interaction mapping being based on information selected from a group consisting of: message characteristics, content characteristics, user behaviors, and user characteristics.

7. (canceled)

8. The method of claim 1, further comprising:
communicating information related to a communication of the digital content to the account of the user; and
training the second AI model based on the communicated information.

9. The method of claim 1, further comprising associating the digital content with an electronic message.

10. A system comprising:
a processor configured to:
receive, by an application, over a network, digital content, the digital content being associated with raw data;
extract, by the application executing a first artificial intelligence (AI) model including a natural language processing (NLP) model, from the digital content, features obtained via tokenization and semantic parsing and determine parameters associated with the digital content based on the extracted features;
generate, by the application executing a second AI model including a graph neural network, based on connections between the determined parameters and user data that are identified by the second AI model, a user-entity interaction mapping, the user-entity interaction mapping indicating a context for which the digital content is to be communicated to an account of a user;
transform, by the application, the raw data for the digital content into executable data based on the generated user-entity interaction mapping, the transformation comprising applying a contextually relevant messaging format to the digital content, the executable data enabling a type of interaction with the digital content by a receiving application of the user; and
cause, by the application, over the network, execution of the type of interaction, the executed type of interaction causing the digital content to be dynamically rendered by the receiving application based on the context and the applied messaging format.

11. The system of claim 10, wherein the processor is further configured such that the transformation involves a set of layers of the raw data, each layer corresponding to a portion of the digital content, such that the type of interaction is configured for each layer.

12. The system of claim 10, wherein the processor is further configured such that the parameters corresponds to a set of information selected from a group consisting of: topic, a communication pattern, transmitted data across a configurable time window, and engagement data.

13. The system of claim 12, wherein the processor is further configured such that the configurable time window is a set of rolling days for which the raw data can be retrieved from a database.

14. The system of claim 10, wherein the processor is further configured to:
determine that a parameter of the digital content corresponds to a type of content;
filter the digital content; and
apply a tag corresponding to the type of content to the digital content.

15. The system of claim 10, wherein the processor is further configured such that the user-entity interaction mapping is based on information selected from a group consisting of: message characteristics, content characteristics, user behaviors, and user characteristics.

16. (canceled)

17. The system of claim 10, wherein the processor is further configured to:
communicate information related to a communication of the digital content to the account of the user; and
train the second AI model based on the communicated information.

18. The system of claim 10, wherein the processor is further configured to associate the digital content with an electronic message.

19. A non-transitory computer-readable storage medium tangibly encoded with computer-executable instructions that when executed by a processor, perform a method comprising:
receiving, by an application, over a network, digital content, the digital content being associated with raw data;
extracting, by the application executing a first artificial intelligence (AI) model including a natural language processing (NLP) model, from the digital content, features obtained via tokenization and semantic parsing and determining parameters associated with the digital content based on the extracted features;
generating, by the application executing a second AI model including a graph neural network, based on connections between the determined parameters and user data that are identified by the second AI model, a user-entity interaction mapping, the user-entity interaction mapping indicating a context for which the digital content is to be communicated to an account of a user;
transforming, by the application, the raw data for the digital content into executable data based on the generated user-entity interaction mapping, the transformation comprising applying a contextually relevant messaging format to the digital content, the executable data enabling a type of interaction with the digital content by a receiving application of the user; and
causing, by the application, over the network, execution of the type of interaction, the executed type of interaction causing the digital content to be dynamically rendered by the receiving application based on the context and the applied messaging format.

20. The non-transitory computer-readable storage medium of claim 19, further comprising:
determining that a parameter of the digital content corresponds to a type of content;
filtering the digital content; and
applying a tag corresponding to the type of content to the digital content.
